(19) United States
(12) Patent Application Publication
(10) Pub. No.: US 2023/0305511 A1
(43) Pub. Date: Sep. 28, 2023

(54) Control Device for At Least One Technical Installation, Technical Installation, Use of a Control Device and Method For Controlling At Least One Technical Installation

(71) Applicant: BYSTRONIC LASER AG, Niederönz (CH)

(72) Inventors: Friedemann SEIBERT, Winterbach/Pfalz (DE); Benjamin ROEDIGER, Ohrdruf (DE)

(73) Assignee: BYSTRONIC LASER AG, Niederönz (CH)

(21) Appl. No.: 18/035,529

(22) PCT Filed: Nov. 4, 2021
(86) PCT No.: PCT/EP2021/080624

§ 371 Date: May 5, 2023

(30) Foreign Application Priority Data
Nov. 6, 2020 (EP) 20206214.7

(51) Int. Cl. G05B 19/18; G05B 19/406; G05B 19/409

(52) U.S. Cl. CPC G05B 19/188; G05B 19/406; G05B 19/409; G05B 2219/36203

(57) ABSTRACT

A control device for at least one technical installation is described herein. The control device includes at least one mobile control unit for controlling the at least one technical installation as well as at least one supply unit, which can be assigned in a fixed manner to the technical installation and be connected thereto in an energy- and signal-transmitting manner for supplying the at least one mobile control unit with energy. The at least one mobile control unit and the at least one supply unit have a device for wireless energy transmission with a transmission frequency within a predetermined distance between the supply unit and the mobile control unit and for wireless transmission of a safety protocol in the course of the energy transmission. Furthermore, a technical installation and a method for controlling a technical installation are specified.

### CROSS REFERENCE TO RELATED APPLICATIONS

This application is a national phase application of International Application No. PCT/EP2021/080624, filed Nov. 4, 2021, which claims priority to European Patent Application 20206214.7, filed Nov. 6, 2020, the content of both of which is herein incorporated by reference.

### BACKGROUND OF THE INVENTION

### Field of the Invention

The present invention relates to a control device for at least one technical installation, a technical installation, a use of a control device and a method for controlling at least one technical installation.

### Description of Related Art

Control elements for technical installations, such as machine tools, in particular bending machines, are typically equipped with emergency stop devices that are unmistakably assigned to a technical installation. In order to ensure that only effective emergency stop devices are recognized as such, the PILZ company, in cooperation with Steute, has developed an emergency stop button that is only illuminated in the colours typical of emergency stop devices when the energy supply is available and otherwise appears in an inconspicuous grey.

To avoid incorrect operation of neighbouring machine tools or confusion of the emergency stop device, control devices of machine tools are typically wire-bound. Tablet controls are an exception, but may only be used to trigger movements that cannot impair the safety, e.g., of a machine tool operator. The wiring of the control devices is a disadvantage because the cables of the wiring must be pulled along with the control devices, are in the way or can be damaged by being run over or kinked.

DE 10 2011 083 817 Al discloses a method for establishing a wireless connection between a communication device and a machine tool. WO2013/189760 Al relates to a coupling system for use in automation technology, which coupling system comprises at least one first device and one second device of automation technology arranged outside the first device, wherein the first device and the second device have a corresponding interface for wirelessly transmitting data and/or energy and wherein at least one first coupling apparatus is arranged on the first device, which first coupli11g apparatus interacts with a second coupling apparatus of the second device, wherein the second device can be detachably fastened to the first device with the aid of the first coupling apparatus and the second coupling apparatus. AT501688 Bl relates to a method and suitable devices for the safe, systematic, exclusive, temporary assignment of the command authorisation of an operator to a controllable technical installation using a mobile control unit, which is technically suitable for the alternate operation of a plurality of controllable technical installations, is usually equipped with safety switch elements, such as an emergency circuit-breaker, approval switch and operating mode selection switch and which nevertheless only uses conventional data transmission elements or network technology comprising no specific safety-related features for the coupling of data to the controllable technical installation. WO2020/087099 Al relates to a method for operating a machine control system and to a machine control system having at least one machine controller for carrying out machine operations, comprising at least one mobile hand-held operating device which can be carried by an operator and is intended to functionally influence one of the machine controllers. EP2617120 Al relates to systems for wireless energy transfer distribution over a defined area. Energy may be distributed over the area via a plurality of repeater, source, and device resonators. The resonators within the area may be tunable and the distribution of energy or magnetic fields within the area may be configured depending on device position and power needs. A method for assigning a processing plan to a mobile unit data set of a mobile unit of an indoor location system of a manufacturing hall is provided. US2020/208989 Al discloses a method which includes: providing a manufacturing control system for industrial processing of workpieces with a machine tool in accordance with workpiece-specific processing plans, each processing plan storing order information for a workpiece to be processed, providing a mobile unit with an image acquisition unit for acquiring image data, mobile unit data set belonging to the mobile unit and position data of the mobile unit acquired with the indoor location system being stored in the manufacturing control system, acquiring image data of a processing plan-specific object for identifying the processing plan to be assigned with the manufacturing control system, and assigning the identified processing plan to the mobile unit data set of the mobile unit in the manufacturing control system. WO2007/062441 Al relates to a position-variable switching device, especially a floor switch, that is connected to a control device optionally of a production device, especially a folding press, in a preferably wireless manner, for signal and/or data transmission. A positioning device is provided for the position variation as required, said positioning device at least comprising a detection device and a progression device formed by a chassis provided with a drive device and at least one progression element.

### BRIEF SUMMARY OF THE INVENTION

It is the object of the invention to specify a control device for a technical installation and a method for controlling at least one technical installation with a control device, by which safety is promoted when controlling the technical installation.

One embodiment of the invention relates to a control device for at least one technical installation, in particular for at least one machine tool, in particular a bending machine, having at least one mobile control unit for controlling the at least one technical installation; and having at least one supply unit, which can be assigned in a fixed manner to the technical installation and can be connected thereto in an energy- and signal-transmitting manner, for supplying the at least one mobile control unit with energy; wherein the at least one mobile control unit and the at least one supply unit have a device for wireless energy transmission with a transmission frequency within a predetermined distance between the supply unit and the mobile control unit and for wireless transmission of a safety protocol in the course of the energy transmission. The control unit includes a safety mat and/or a foot control element, wherein the supply unit is contained in the safety mat and/or in the foot control element and/or is configured as such.

The control device enables the at least one mobile control unit to be supplied with energy and a safety protocol and, optionally, with other data wirelessly and at a precisely definable location. Since only in the case of wireless energy transmission to the mobile control unit, the safety protocol is also transmitted and executed wirelessly, thus enabling control of the installation, the safety of the technical installation is promoted. Since the supply unit can be assigned to the installation in a fixed location, it is not part of the installation and/or not integrated into the installation. The supply unit is thus provided as a separate unit that can be connected to the installation for energy and signal transmission. Therefore, the mobile control unit can be located and/or operated at a distance from the technical installation. This additionally promotes the safety of the technical installation, especially the safety of the operators. To further increase this effect, the supply unit can additionally be arranged and/or operated at a distance from the technical installation.

In addition, in the course of wireless energy transmission from the fixed supply unit to the mobile control unit, its location can be determined. Furthermore, the energy, data as well as safety protocol transmission between the supply unit and the mobile control unit is realized without interfering wiring that may compromise safety. In addition, safety during operation of the technical installation is increased by the fact that the at least one mobile control unit can only be supplied with energy and the safety protocol only be executed within the predetermined distance from the at least one supply unit. Incorrect operation of neighbouring technical installations, such as machine tools, can thus be avoided, since the mobile control unit only functions within the predetermined distance from its assigned supply unit and thus neighbouring, unassigned technical installations cannot be controlled. This reduces the risk of confusion. Confusion of emergency stop devices of neighbouring technical installations can also be avoided. This is because the mobile control unit and its emergency stop device are supplied with energy and, for example, an emergency stop switch provided on the mobile control unit is illuminated only within the predetermined distance from its assigned supply unit.

The control device of embodiments may therefore increase the safety of safety-related technical installations. In particular, machine safety can be supported according to performance level, by standards for general machine safety and/or, for example, the C standard for hydraulic press brakes (EN12622)

A mobile control unit can be designed to control several technical installations, each with one or more supply units. Furthermore, several mobile control units can be designed to control a technical installation by means of one or more supply units. For example, several mobile control units can be used in a linked manner within the predetermined distance for a technical installation, especially when processing large workpieces, i.e., workpieces with extensive dimensions. For example, the technical installation can be controlled by two operators and both operators must simultaneously operate one mobile control unit each to process the workpiece, which increases safety when operating the technical installation. Furthermore, several mobile control units can be used for several technical installations, whereby, for example, only one mobile control unit is active at a time at a particular technical installation, such as a tool station. In this way, frequent transport of the mobile control unit between different technical installations or tool stations can be avoided.

In the embodiment presented above, the safety protocol may be at least partially tuned to and/or at least partially modulated onto the transmission frequency. In this way, the safety protocol can be easily transmitted together with the energy. Furthermore, the safety protocol can be configured as a sequence of signals, in particular as signals interchangeable between the supply unit and the mobile control unit.

The supply unit may include at least one means for energy transmission and signal exchange. The mobile control unit may include at least one means for energy reception and signal exchange. The predetermined distance may be 0-100 cm, preferably 1-50 cm, particularly preferably 1-10 cm, between the supply unit and the mobile control unit, in particular between the means for energy transmission and signal exchange and the means for energy reception and signal exchange. This distance promotes the safety of the installation.

The supply unit, in particular the means for energy transmission and signal exchange, can be integrated in a safety mat or in a foot switch or foot control element. The control unit can include a safety mat and/or a foot control element, wherein the supply unit, in particular the means for energy transmission and signal exchange, is contained in the safety mat and/or in the foot control element and/or is configured as such. In the case of the safety mat, the function of the step protection can thus be combined with the other advantages of the mobile control unit. The supply unit can be provided as a separate unit that can be connected to the installation for energy and signal transmission. In one example, the supply unit may be integrated into a floor of a factory building.

The supply unit, in particular the means for energy transmission and signal exchange, can be designed to transmit the energy and/or exchange the signals by means of electromagnetic radiation, in particular by means of magnetic induction, radio waves and/or light. Furthermore, the mobile control unit, in particular the means for energy reception and signal exchange, can be designed to receive the energy and/or exchange the signals by means of electromagnetic radiation, in particular by means of magnetic induction, radio waves and/or light. In this way, energy transmission and signal exchange can be reliably realized wirelessly. For example, the supply unit and the mobile control unit may each have at least one electric coil. Embodiments may be configured for energy transmission via inductive coupling, resonant inductive coupling, capacitive coupling, laser, and/or microwaves.

The means for energy reception and signal exchange of the mobile control unit and the means for energy transmission and signal exchange of the supply unit can be tuned or be tunable with one another. Furthermore, the predetermined distance between the supply unit and the mobile control unit may be predetermined by a maximum transmission distance between the transmission units of the device for wireless energy transmission, e.g., a predetermined range of the device for wireless energy transmission or its means for energy transmission and/or energy reception.

At least two supply units, in particular at least two safety mats, can be connected with one another in a mechanical, energy-transmitting, signal-transmitting and/or data-transmitting manner or be connectable in such manners. Corresponding interfaces can be provided on the supply units for this purpose. For example, multiple safety mats can be connected or be connectable to form a combination, also referred to as a cluster. In this regard, the dimensioning of the supply units can be adapted to the dimensioning of the mobile control unit and/or to the dimensioning of the at least one technical installation. Further, the resulting dimensioning of the connected or connectable supply units may be adapted to the dimensioning of the at least one technical installation. The dimensioning of the supply units and/or the predetermined distance can further be selected in such a way that, by means of those of the connected supply units which are located within the predetermined distance from the mobile control unit, the energy from one of the technical installations can be or is transmitted wirelessly to the mobile control unit. For example, in a cluster of connected safety mats, the energy and safety protocol transmission can be performed only at the location of the mobile control unit to be supplied, i.e., via the safety mat(s) at whose predetermined distance the mobile control unit is located. In this regard, the safety mats located outside the predetermined distance can be inactive or switched to a standby state.

Furthermore, the safety protocol may include a one-way or two-way authentication and/or a one-way or two-way functionality check of the supply unit, the mobile control unit and/or the technical installation. In this way, safety is additionally promoted in relation to the operation of the technical installation. In particular, the mutual authentication of the supply unit, the mobile control unit and/or the technical installation, e.g., at the beginning of the wireless energy transmission, reduces the risk of confusion, especially with regard to neighbouring technical installations.

At least one element selected from the at least one supply unit and the at least one mobile control unit can have a control module that is connected or can be connected to a central controller of the technical installation in a data-transmitting manner, in particular with a wireless and/or wired connection. In this regard, the at least one supply unit and/or the at least one mobile control unit can be designed, in particular by means of the respective control module, for wireless energy transmission from one of the technical installations to the mobile control unit only on condition that the mobile control unit is arranged within the predetermined distance from the supply unit. Furthermore, the at least one supply unit and/or the at least one mobile control unit may be designed, in particular by means of the respective control module, for wireless transmission of at least part of the energy from one of the technical installations to the mobile control unit only on condition that the mobile control unit is registered with the central controller of one of the technical installations. This promotes safety when operating the technical installation.

The at least one supply unit may be configured to switch to a de-energized state and/or standby state in the absence of wireless energy transmission and/or in the absence of wireless signal transmission and/or outside the predetermined distance from the mobile control unit. At least one element selected from the at least one supply unit, the at least one mobile control unit, the control module of the supply unit, and the control module of the at least one mobile control unit may be configured to determine the connection of the at least one mobile control unit to the technical installation during wireless energy transmission to the mobile control unit and/or wireless signal transmission to the mobile control unit. In this manner, not only the operational readiness and/or functionality, but also the location of the mobile control unit can be determined.

One embodiment of the invention further relates to a technical installation, machine tool or bending machine, in particular a safety-related technical installation, machine tool or bending machine, with a control device according to one of the embodiments and configurations described above. The supply unit for supplying the at least one mobile control unit with energy can be assigned or is assignable to the technical installation, machine tool or bending machine in a fixed location and can be connected or is connectable to the installation, machine tool or bending machine in an energy-transmitting and signal-transmitting manner.

A further embodiment of the invention relates to a use of a control device according to one of the embodiments and configurations described above for controlling at least one technical installation, machine tool or bending machine, in particular a safety-related technical installation, machine tool or bending machine.

Another embodiment of the invention relates to a method for controlling at least one technical installation with a control device, in particular with a control device according to one of the above embodiments and configurations, in particular for controlling at least one machine tool or at least one bending machine, the control device having at least one mobile control unit for controlling the at least one technical installation and at least one supply unit for supplying the at least one mobile control unit with energy; the supply unit being assigned to the technical installation in a fixed manner and being connected thereto in an energy-transmitting and signal-transmitting manner; wherein the method comprises the following: Supplying energy to at least one of the mobile control units, wherein within a predetermined distance between one of the supply units and the mobile control unit, the energy is wirelessly transmitted at a transmission frequency, and wherein in the course of the energy transmission, a safety protocol is wirelessly transmitted.

The at least one technical installation can be controlled via the supply unit using the mobile control unit in a connected manner. As a safety protocol, signals can be exchanged wirelessly between the supply unit and the mobile control unit. The safety protocol can be transmitted as a sequence of signals. The safety protocol can be at least partially tuned to and/or at least partially modulated onto the transmission frequency.

In all embodiments, the supply unit can be provided as a separate unit from the installation and/or from the mobile control unit. Furthermore, in all embodiments, the supply unit and/or the mobile control unit may each be or become arranged and/or be operated at a distance from the installation.

With the above-mentioned technical installation, the use of a control device and/or the method for controlling at least one technical installation, the same advantages, operating modes and functions can be realized as with the embodiments and configurations of the control device for at least one technical installation, in particular with identical and/or analogous features.

### BRIEF DESCRIPTION OF THE SEVERAL VIEWS OF THE DRAWINGS

Further advantages features and details of the various embodiments of this disclosure will become apparent from the ensuing description of a preferred exemplary embodiment or embodiments and further with the aid of the drawings. The features and combinations of features recited below in the description, as well as the features and feature combination shown after that in the drawing description or in the drawings alone, may be used not only in the particular combination recited but also in other combinations on their own without departing from the scope of the disclosure.

The following is an advantageous embodiment of the invention with reference to the accompanying figures, wherein:

FIG. 1 schematically depicts an example of a control device 10 for at least one technical installation, according to embodiments of the invention;

FIGS. 2a and 2b each schematically depict the control device 10 with a technical installation 100; and

FIGS. 3a to 3c schematically depict an example of a method for controlling at least one technical installation, according to embodiments of the invention.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including not only one of A, only one of B, only one of C, or any combination of A, B, and C.

The term “supply unit that can be assigned to the technical installation in a fixed manner” means that the supply unit can be assigned to the technical installation in a fixed manner, e.g., can be provided in a fixed location on the technical installation and/or can be identified as being provided in a fixed manner on the technical installation by signals or data transmission. The expression “is assigned to the technical installation in a fixed manner” means that the supply unit is provided in a fixed location on the technical installation and/or is identified as being provided in a fixed manner on the technical installation. The term “for wireless energy transmission with a transmission frequency within a predetermined distance” means that the device for wireless energy transmission enables wireless energy transmission with a transmission frequency and wireless transmission of a safety protocol and optional further data in the course of the energy transmission when the supply unit and the mobile control unit, in particular their means for energy transmission and their means for energy reception, are at least partially within the predetermined distance. In the following description of embodiments and examples, the terms technical installation and machine are used synonymously. Also, embodiments of the invention are described below with reference to a bending machine as a technical installation or machine, without limiting the invention thereto. Furthermore, the mobile control unit is also referred to as a control unit in the following. Furthermore, where value ranges are described here, the specification of a broad range with narrower alternative or preferred ranges is also considered to disclose ranges that can be formed by any combination of specified lower range limits and specified upper range limits. The terms “size” or “dimensioning” are to be understood as referring to the “dimensions” in the present case.

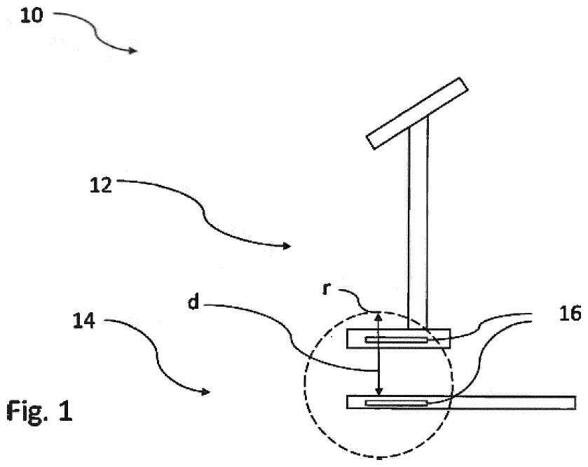

FIG. 1 schematically shows a control device 10 for a technical installation as an example. The control device 10 has a mobile control unit 12 for controlling the technical installation and a supply unit 14 for supplying the mobile control unit 12 with energy.

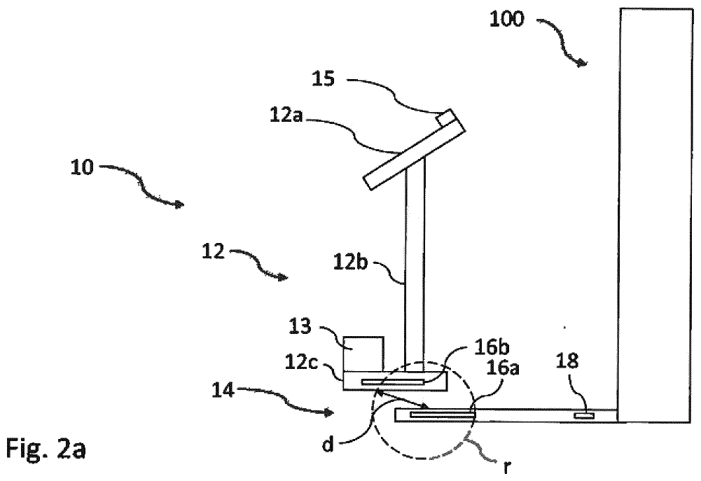

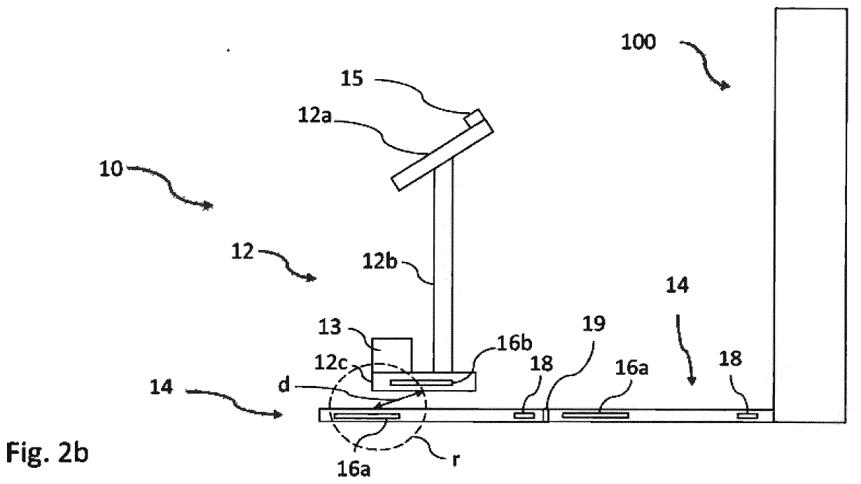

As shown in FIG. 2a, in the present example, the mobile control unit 12 includes a display and input device 12a, such as a touch screen, at its upper end, a base element 12c at its lower end, and a stand element 12b between the display and input device 12a and the base element 12c. Casters (not shown) may be provided in the base element 12c for moving the mobile control unit 12 on the floor. In the present example, a foot switch 13 is arranged in the base element 12c, which can be actuated by an operator of the technical installation with his foot for controlling the same. Furthermore, an emergency stop switch 15 is provided in the display and input device 12a, which can be actuated by the operator to stop the technical installation in emergency situations.

In examples, the technical installation can be controlled by means of the control device 12 in addition to or as an alternative to the foot switch 13 by means of the display and input device 12a. For example, no foot switch may be provided in the mobile control unit 12, and the technical installation may be controllable solely by means of the display and input device 12a. In other examples, no display and input device 12a may be provided in the mobile control unit 12, and the technical installation may be controllable solely by means of the foot switch 13. In further examples, both the foot switch 13 and the display and input device 12a may be provided in the control device 10 and may each be used individually and/or in combination to control the technical installation.

The control device 10 includes a supply unit 14 for supplying the mobile control unit 12 with energy. In the present example, the supply unit 14 is designed as a floor mat, also referred to as a charging mat 14 in the present case. The supply unit 14 can be designed, for example, as a safety mat and/or ergonomic rubber mat.

As shown in FIG. 1, the mobile control unit 12 and the supply unit 14 have a device 16 for wireless energy transmission with a transmission frequency within a predetermined distance d between the supply unit and the control unit. In the present example, the device 16 for wireless energy transmission with a transmission frequency includes a means 16a for energy transmission and signal exchange and a means 16b for energy reception and signal exchange. In the figures, the predetermined distanced is portrayed in an exemplary manner as the radius of a dashed circle illustrating the spatial extent of a transmission ranger of the device for wireless energy transmission, in the present examples of the means 16a for energy transmission and signal exchange. The transmission ranger is also referred to just as the ranger here.

In the present example, the device 16 has two electric coils 16a and 16b. The coil 16b is arranged in the base element 12c of the control unit 12 in the present case as the means for energy reception and signal exchange, and the coil 16a is arranged in the charging mat 14 as the means for energy transmission and signal exchange.

In embodiments, the energy transmission may be performed by means of magnetic induction with a transmission frequency of some 10 kHz, preferably less than 1 kHz, more preferably in a range of 87 to 250 Hz, and/or with a power of 0.3 to 15 W, preferably 1 to 5 W, more preferably 1 to 3 W. The predetermined distanced d (transmission ranger) between the charging mat 14 and the mobile control unit 12 may range be from O to 100 cm, preferably O to 10 cm, more preferably O to 2 cm. The predetermined distanced d can be defined in particular by the maximum transmission distance between the coils 16a and 16b. In examples, the maximum transmission distance can be less than the diameter of at least one of the coils 16a and 16b. Furthermore, the signal exchange can be performed in the same frequency range as the frequency transmission, e.g., with a transmission speed of up to 2 kilobits per second.

In the present example, coil 16a has a diameter of approximately 50 mm, while coil 16b has a diameter of approximately 40 mm. In other examples, multiple, overlapping coils 16a and/or multiple, overlapping coils 16b may be provided. In the present case, the coil 16a transmits energy to the coil 16b by means of magnetic induction with a transmission frequency in a range of 100 to 200 Hz and with a power of 3 to 4 W, within the predetermined distance d (transmission range r) between the charging mat 14 and the mobile control unit 12 of O to 10 cm. Furthermore, the signal exchange in this example is performed in a frequency range from 100 to 150 Hz, with a transmission speed of 1 kilobit per second. In the present example, the mobile control unit 12 is additionally equipped with an accumulator (not shown), also referred to as a battery, in which the transmitted energy can be stored. Alternatively or additionally, at least one capacitor can be provided to store the transmitted energy.

In alternative examples, antennas can be used instead of coils, and the energy and safety protocol can be transmitted using radio waves, for example.

In operation of the present example, as shown in FIG. 2a, the supply unit 14, i.e., the charging mat 14, is or will be assigned to a technical installation 100 in a fixed manner and is connected to this installation in an energy-transmitting and data-transmitting manner with a wireless or wired connection. The supply unit 14, or charging mat 14, is not part of the installation 100. The charging mat 14 is provided as a separate unit that can be connected to the installation in an energy-transmitting and signal-transmitting manner. By way of example, the supply unit 14 has a control module 18 that is connected to a central controller of the technical installation 100 in a data-transmitting manner. Further, an energy supply (not shown) of the supply unit 14 coupled to the coil 16a is connected to the energy supply (not shown) of the technical installation 100. To control the technical installation 100, the mobile control unit 12 with its coil 16b is positioned within the predetermined distance d, i.e., within the transmission range r, in the vicinity of the supply unit 14. Due to this, the coil 16b is within the maximum transmission distance of the coil 16a, i.e., at least partially within the ranger. The mobile control unit 12 is supplied with energy by means of the coils 16a and 16b, whereby within the predetermined distanced between the supply unit 14 and the mobile control unit 12, the energy is transmitted wirelessly at the transmission frequency from the coil 16a to the coil 16b. In the course of the energy transmission, a safety protocol is transmitted wirelessly. In addition, the mobile control unit 12 can be localized in the process, i.e., its location can be determined.

FIG. 2b illustrates that, in some examples, the supply unit 14 is modularly expandable by coupling with additional supply units 14. Multiple supply units 14 may be connected to each other in a direction perpendicular to the technical installation 100 to form a cluster, as shown in FIG. 2b using two supply units 14. For this purpose, the supply units 14 can be connected with one another in a mechanical, energy-transmitting, signal-transmitting and/or data-transmitting manner or be connectable in such manners, for example by means of at least one interface 19. Alternatively or additionally, multiple supply units 14 may be coupled in a direction parallel to the technical installation 100, which may be 1 to 8 m long in the case of bending machines, for example. In this way, the size, i.e., the dimensions, of the at least one supply unit 14 is/are adaptable to the size, i.e., the dimensions, of the technical installation 100. The energy and the safety protocol and optionally other data are transmitted during operation by that/those supply unit(s) 14 within whose ranger the control unit 12 is located. Thus, in the example of FIG. 2b, if the control device 12 is moved above the cluster of supply units 14 from the predetermined distanced to one of the supply units 14, the energy and data exchange automatically continues with that supply unit 14 or those supply units 14 relative to which the control unit 12 is located within the respective predetermined distance d.

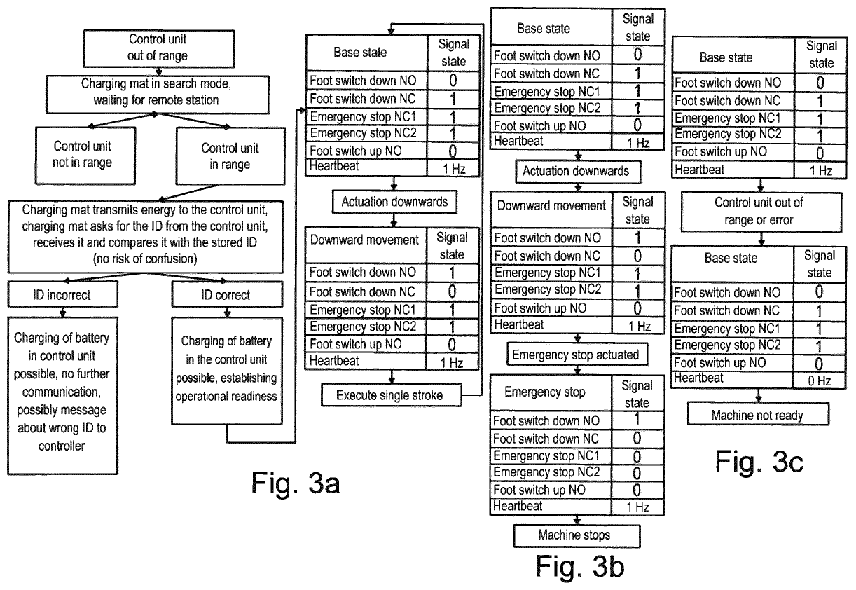

FIGS. 3a to 3c schematically show an example of a method for controlling the technical installation 100 with the control device 10. In the case of this example, the technical installation 100 is a bending machine that is actuated, for example, by moving its movable upper beam, on which a bending tool is provided, downward for bending a workpiece. By means of the mobile control unit 12, at least the commands for moving the upper beam downward and upward and for the emergency stop can be triggered in order to control the bending machine.

In the present example, the safety protocol includes requesting and checking an identification number ID of the control unit 12. Optionally, as shown in FIGS. 3a to 3c, the connection establishment and/or control signals can be at least partially integrated into the safety protocol, in particular signal states and signal sequences for the foot switch 13 and/or the emergency stop switch 15 and/or for testing a heartbeat of the control unit 12. The safety protocol and optionally other signals can be modulated onto the transmission frequency at least partially with a natural frequency in the same frequency range as the energy transmission.

FIG. 3a illustrates a connection establishment, also called handshake/pairing, between the mobile control unit 12 and the supply unit 14 at the beginning of the method. As illustrated in FIG. 3a, the control unit 12 is initially located outside the predetermined distanced from the supply unit 14, in this case the charging mat 14. This means that the control unit 12 is positioned outside the transmission ranger to the charging mat 14. The charging mat 14 is in search mode, in which it waits for the control unit 12 as a remote station. As long as the control unit 12 is not within ranger and the coils 16a and 16b are not within their maximum transmission distance, the bending machine 100 cannot be operated.

When the control unit 12, in particular its coil 16b, is transported at least partially to within the predetermined distanced from the charging mat 14, the control unit is within the ranger of the charging mat 14. The charging mat 14 then transmits energy with its coil 16a to the coil 16b of the control unit 12. The safety protocol is executed. The charging mat 14 requests the ID of the control unit 12 from the control unit, receives the ID, and matches the ID with one or more stored IDs indicating one or more target IDs. In the present example, if the ID transmitted by the control unit 12 is incorrect, i.e., does not match one of the desired target IDs, energy may be transmitted at least briefly to the control unit 12 and charged into the battery of the control unit, but no further communication related to the operation of the bending machine 100 takes place between the control unit 12 and the charging mat 14. In this case, the control module 18 of the charging mat 14 can be used to report to the central controller of the bending machine 100 the receipt of an incorrect ID and/or also the location of the control unit 12 with the incorrect ID, but no operational readiness of the bending machine 100 is established.

If the ID transmitted by the control unit 12 is correct and matches the target ID, the charging mat 14 is connected to the desired control unit 12 in an energy-transmitting and data-transmitting manner. This makes it possible to assign the control unit 12 to the bending machine 100 in accordance with the intended purpose and without risk of confusion, so that an undesired assignment of the control unit 12 to a neighbouring bending machine, for example, can be avoided. The control unit 12 is supplied with energy and its battery is charged. Furthermore, the operational readiness of the bending machine 100 is established and operation of the bending machine 100 with the control unit 12 of the correct ID is enabled.

As shown in the example of FIG. 3a, after the connection is established, the bending machine 100 can be operated with the foot switch 13, starting from a base state. In the base state, the signal states are foot switch down (downward) NO (normally open) 0 and foot switch down NC (normally closed) 1. Two signal states NC 1 and NC 2 for the emergency stop switch 15 are each set to 1 in the base state and the signal state foot switch up (upward) NO is set to 0. In the present example, a heartbeat of the control unit 12 is detected by the supply unit 14 within the ranger. The heartbeat of the control unit 12 corresponds to 1 Hz in the base state. Now the foot switch 13 is actuated by the operator and a downward movement of the upper beam of the bending machine is commanded. This switches the signal states foot switch down NO to 1 and NC to 0. A single stroke of the upper beam is performed. Eventually, the machine returns to the base state.

FIG. 3b shows how an emergency stop of the bending machine 100 can be triggered during the stroke of FIG. 3a. Here, for example during the downward movement of the upper beam, the emergency stop switch 15 on the display and input device 12a is actuated. As a result, the signal states emergency stop NC 1 and NC 2 are each set to 0, which stops the bending machine 100.

FIG. 3c illustrates a malfunction of the connection between the control unit 12 and the charging mat 14. The bending machine 100 is, for example, in its base state. If the transmission of energy between the charging mat 14 and the control unit 12 is interrupted, e.g., because of a fault, a malfunction or because the control unit 12 is moved out of the ranger to the charging mat 14, the signal state of the heartbeat of the control unit 12 changes to O Hz. This terminates the operational readiness of the bending machine 100.

Finally, it should be noted that the description of the invention and the exemplary embodiments are not to be understood as limiting in terms of a particular physical realisation of the invention.

The scope of protection of the present invention is given by the claims and is not limited by the features illustrated in the description or shown in the figures.

1.-19. (canceled)

20. A control device for at least one of a technical installation, at least one machine tool, and a bending machine, comprising:
at least one mobile control unit for controlling the at least one technical installation; and
at least one supply unit, configured to be assigned in a fixed manner to the technical installation and connected thereto in an energy- and signal-transmitting manner, for supplying the at least one mobile control unit with energy; and
wherein the at least one mobile control unit and the at least one supply unit comprise a device for wireless energy transmission with a transmission frequency within a predetermined distance between the supply unit and the mobile control unit and for wireless transmission of a safety protocol in the course of the energy transmission; and
wherein the control device further comprises a safety mat and/or a foot control element, wherein the supply unit is at least one of configured and contained in at least one of the safety mat and the foot control element.

21. The control device according to claim 20, wherein:
the safety protocol is at least partially tuned to and/or at least partially modulated onto the transmission frequency; and/or
wherein the safety protocol is configured as at least one of a sequence of signals and signals interchangeable between the supply unit and the mobile control unit.

22. The control device according to claim 20, wherein at least one of:
the supply unit comprises at least one means for energy transmission and signal exchange;
the mobile control unit comprises at least one means for energy reception and signal exchange; and
the predetermined distance between at least one of the supply unit and the mobile control unit, the means for energy reception and signal exchange, and means for energy reception and signal exchange, is at least one of 0-100 cm, 1-50 cm, and 1-10 cm.

23. The control device according to claim 20, wherein at least one of:
at least one of the supply unit and the means for energy transmission and signal exchange, is configured to transmit the energy and/or exchange the signals by means of at least one of electromagnetic radiation, magnetic induction, radio waves and light; and
at least one of the mobile control unit and the means for energy reception and for signal exchange, is configured to receive the energy and/or exchange the signals by means of at least one of electromagnetic radiation, magnetic induction, radio waves and light.

24. The control device according to claim 23, wherein the means for energy reception and signal exchange of the mobile control unit and the means for energy transmission and signal exchange of the supply unit are tuned or are tunable with one another.

25. The control device according to claim 20, wherein at least one of at least two supply units and at least two safety mats, are connected or configured to be connectable with one another in at least one of a mechanical, energy-transmitting, signal-transmitting and data-transmitting manner.

26. The control device according to claim 25, wherein at least one of:
the dimensioning of the supply units is adapted to at least one of the dimensioning of the mobile control unit and the dimensioning of the at least one technical installation (100);
the resulting dimensioning of the connected or connectable supply units is adapted to the dimensioning of the at least one technical installation.

27. The control device according to claim 25, wherein the dimensioning of the supply units and/or the predetermined distance is selected such that, by means of the connected supply units located within the predetermined distance from the mobile control unit, the energy from one of the technical installations is at least one of configured to be transmitted and transmitted wirelessly to the mobile control unit.

28. The control device according to claim 20, wherein the safety protocol comprises at least one of a one-way authentication, a two-way authentication, a one-way functionality check of the supply unit, a two-way functionality check of the supply unit, the mobile control unit and the technical installation.

29. The control device according to claim 20, wherein at least one of the at least one supply unit and the at least one mobile control unit comprises a control module connected or configured to be connected to a central controller of the technical installation in at least one of a data-transmitting manner, a wireless connection and a wired connection.

30. The control device according to claim 28, wherein at least one of:
the at least one supply unit and/or the at least one mobile control unit is configured by means of the respective control module to transmit a wireless energy transmission from one of the technical installations to the mobile control unit only on condition that the mobile control unit is arranged within the predetermined distance from the supply unit; and
the at least one supply unit and/or the at least one mobile control unit is configured by means of the respective control module to transmit a wireless transmission of at least part of the energy from one of the technical installations to the mobile control unit only on condition that the mobile control unit is registered with the central controller of one of the technical installations.

31. The control device according to claim 20, wherein at least one of:
the at least one supply unit is configured to switch to a de-energized state and/or standby state in the absence of a wireless energy transmission and/or in the absence of a wireless signal transmission and/or outside the predetermined distance (d) from the mobile control unit; and/or
at least one element selected from the at least one supply unit and the at least one mobile control unit is configured to determine the connection of the at least one mobile control unit to the technical installation during wireless energy transmission to the mobile control unit and/or wireless signal transmission to the mobile control unit.

32. The control device according to any one of claim 29, wherein at least one of the control module of the supply unit and the control module of the at least one mobile control unit is configured to determine the connection of the at least one mobile control unit to the technical installation during wireless energy transmission to the mobile control unit and/or wireless signal transmission to the mobile control unit.

33. A technical installation, machine tool or bending machine, comprising:
a control device for at least one of at least one technical installation, at least one machine tool, a bending machine,
at least one mobile control unit configured to control the at least one technical installation; and
at least one supply unit configured to be assigned in a fixed manner to the technical installation and can connected thereto in an energy- and signal-transmitting manner, for supplying the at least one mobile control unit with energy; and
wherein the at least one mobile control unit and the at least one supply unit have a device for wireless energy transmission with a transmission frequency within a predetermined distance between the supply unit and the mobile control unit and for wireless transmission of
wherein the control device further comprises a safety mat and/or a foot control element, and
wherein the supply unit is at least one of contained and configured to be contained in at least one of the safety mat and the foot control element.

34. The technical installation according to claim 33, wherein the supply unit for supplying the at least one mobile control unit with energy is configured to be assigned or is assigned to the technical installation, machine tool or bending machine in a fixed location and further configured to be connected or arranged connected to the installation, machine tool or bending machine in an energy-transmitting and signal-transmitting manner.

35. A method for controlling at least one technical installation with a control device, the method comprising the steps of:
providing a control device configured to control at least one machine tool or at least one bending machine, the control device comprising at least one mobile control unit configured to control the at least one technical installation and at least one supply unit for supplying the at least one mobile control unit with energy;
assigning the supply unit to the technical installation in a fixed manner, such that the supply unit is connected to the technical installation in an energy-transmitting and signal-transmitting manner;
supplying energy to at least one of the mobile control units, wherein within a predetermined distance between one of the supply units and the mobile control unit, the energy is wirelessly transmitted at a transmission frequency, and
wherein in the course of the energy transmission, a safety protocol is wirelessly transmitted.

36. The method according to claim 35, wherein at least one of:
the at least one technical installation is configured to be controlled via the supply unit by the mobile control unit;
signals are wirelessly exchanged between the supply unit and the mobile control unit as a safety protocol;
the safety protocol is transmitted as a sequence of signals; and
the safety protocol is at least partially tuned to and/or at least partially modulated onto the transmission frequency.
